(19) United States
(12) Patent Application Publication
(10) Pub. No.: US 2025/0242257 A1
(43) Pub. Date: Jul. 31, 2025

(54) INTERACTION CONTROL METHOD AND APPARATUS FOR VIRTUAL OBJECTS

(71) Applicant: Tencent Technology (Shenzhen) Company Limited, Shenzhen (CN)

(72) Inventor: Fenlin Cai, Shenzhen (CN)

(21) Appl. No.: 19/088,159

(22) Filed: Mar. 24, 2025

Related U.S. Application Data
(63) Continuation of application No. PCT/CN2024/073459, filed on Jan. 22, 2024.

(30) Foreign Application Priority Data
Mar. 22, 2023 (CN) 202310325401.3

(51) Int. Cl. A63F 13/577; A63F 13/58

(52) U.S. Cl. CPC A63F 13/577; A63F 13/58

(57) ABSTRACT

An interaction control method and apparatus for virtual objects are provided. The method may be performed by a computer device and may include: displaying a virtual scene interface with a first virtual object being displayed in the virtual scene interface; displaying, in the virtual scene interface in response to a controlled virtual object hitting the first virtual object, that the first virtual object flies along a first flight trajectory after being hit; and displaying, in the virtual scene interface in response to a target part of the first virtual object being hit by a second virtual object in a flight process and the second virtual object satisfying a preset condition, that the first virtual object flies along a second flight trajectory after being hit.

### RELATED APPLICATION

This application is a continuation application of PCT Application PCT/CN2024/073459, filed Jan. 22, 2024, which claims priority to Chinese Patent Application No. 202310325401.3, filed on Mar. 22, 2023, each entitled “INTERACTION CONTROL METHOD AND APPARATUS FOR VIRTUAL OBJECTS, DEVICE, MEDIUM, AND PRODUCT”, and each of which is incorporated herein by reference in its entirety.

### FIELD

Aspects described herein generally relate to the field of computer technologies, and in particular, to an interaction control method and apparatus for virtual objects.

### BACKGROUND

A virtual scene generally includes a plurality of types of virtual objects, for example, a controlled virtual object controlled by a player and a first virtual object of a non-player character (NPC) type.

### SUMMARY

Aspects described herein generally relate to providing an interaction control method and apparatus for virtual objects. According to the method, efficiency of human-computer interaction is improved. Technical solutions are as follows.

An aspect described herein may provide an interaction control method for virtual objects. The method includes:
displaying a virtual scene interface, a first virtual object being displayed in the virtual scene interface;
displaying, in the virtual scene interface and in response to a controlled virtual object hitting the first virtual object, that the first virtual object flies along a first flight trajectory after being hit, the controlled virtual object being a virtual object controlled by a terminal; and
displaying, in the virtual scene interface and in response to a target part of the first virtual object being hit by a second virtual object in a flight process and the second virtual object satisfying a preset condition, that the first virtual object flies along a second flight trajectory after being hit.

Another aspect described herein may provide an interaction control method for virtual objects. The method includes:
determining, in response to a controlled virtual object in a virtual scene hitting a first virtual object, a first hit direction of the first virtual object based on a direction of an extension line of a connecting line between a root skeleton point of the controlled virtual object and a root skeleton point of the first virtual object, and determining a first flight trajectory based on the first hit direction as well as a first speed and a virtual weight of the first virtual object, so that the first virtual object flies along the first flight trajectory after being hit, the controlled virtual object being a virtual object controlled by a terminal; and
determining, in response to a target part of the first virtual object being hit in a flight process, a second hit direction of the first virtual object based on a direction of an extension line of a connecting line between a virtual prop hitting the first virtual object and the root skeleton point of the first virtual object, and determining a second flight trajectory based on the second hit direction as well as a second speed and the virtual weight of the first virtual object, so that the first virtual object flies along the second flight trajectory after being hit,
the first speed being a speed of the first virtual object in the first hit direction, and the second speed being a speed of the first virtual object in the second hit direction.

Another aspect described herein may provide an interaction control apparatus for virtual objects. The apparatus includes:
an interface display module, configured to display a virtual scene interface, a first virtual object being displayed in the virtual scene interface; and
a flight display module, configured to display, in the virtual scene interface in response to a controlled virtual object hitting the first virtual object, that the first virtual object flies along a first flight trajectory after being hit, the controlled virtual object being a virtual object controlled by a terminal.

The flight display module is further configured to display, in the virtual scene interface in response to a target part of the first virtual object being hit by a second virtual object in a flight process and the second virtual object satisfying a preset condition, that the first virtual object flies along a second flight trajectory after being hit.

Another aspect described herein may provide an interaction control apparatus for virtual objects. The apparatus includes:
a first trajectory determining module, configured to determine, in response to a controlled virtual object in a virtual scene hitting a first virtual object, a first hit direction of the first virtual object based on a direction of an extension line of a connecting line between a root skeleton point of the controlled virtual object and a root skeleton point of the first virtual object, and determine a first flight trajectory based on the first hit direction as well as a first speed and a virtual weight of the first virtual object, so that the first virtual object flies along the first flight trajectory after being hit, the controlled virtual object being a virtual object controlled by a terminal; and
a second trajectory determining module, configured to determine, in response to a target part of the first virtual object being hit in a flight process, a second hit direction of the first virtual object based on a direction of an extension line of a connecting line between a virtual prop hitting the first virtual object and the root skeleton point of the first virtual object, and determine a second flight trajectory based on the second hit direction as well as a second speed and the virtual weight of the first virtual object, so that the first virtual object flies along the second flight trajectory after being hit,
the first speed being a speed of the first virtual object in the first hit direction, and the second speed being a speed of the first virtual object in the second hit direction.

Another aspect described herein may provide a computer device, including a processor and a memory, the memory being configured to store at least one segment of computer program, and the at least one segment of computer program being loaded and executed by the processor to implement the interaction control method for virtual objects.

Another aspect described herein may provide a computer-readable storage medium having at least one segment of computer program stored therein, the at least one segment of computer program being loaded and executed by a processor to implement the interaction control method for virtual objects.

Another aspect described herein may provide a computer program product, including a computer program, the computer program being stored in a computer-readable storage medium, a processor of a computer device reading the computer program from the computer-readable storage medium, and the processor executing the computer program, to cause the computer device to perform the interaction control method for virtual objects in any one of the foregoing implementations.

### BRIEF DESCRIPTION OF THE DRAWINGS

FIG. 1 is a schematic diagram of an example.

FIG. 2 is a flowchart of an example interaction control method for virtual objects.

FIG. 3 is a flowchart of another example interaction control method for virtual objects.

FIG. 4 is a flowchart of another example interaction control method for virtual objects.

FIG. 5 is a schematic diagram of an example determination of a hit direction.

FIG. 6 is a schematic diagram of an example flight process.

FIG. 7 is a flowchart of another example interaction control method for virtual objects.

FIG. 8 is an example schematic diagram of bumping into a virtual object.

FIG. 9 is another example schematic diagram of bumping into a virtual object.

FIG. 10 is an example schematic diagram of interaction between virtual objects.

FIG. 11 is a flowchart of another example interaction control method for virtual objects.

FIG. 12 is a flowchart of another example interaction control method for virtual objects.

FIG. 13 is an example schematic diagram of interruption priorities of a plurality of states.

FIG. 14 is a block diagram of an example interaction control apparatus for virtual objects.

FIG. 15 is a block diagram of another example interaction control apparatus for virtual objects.

FIG. 16 is a block diagram of an example terminal.

FIG. 17 is a block diagram of an example server.

### DETAILED DESCRIPTION

The technical solutions will be described below clearly and comprehensively in conjunction with accompanying drawings of the examples described in this application. The words such as “first” and “second” may be used to distinguish between same or similar items that have substantially same effects and functions. There is no logical or temporal dependency between “first”, “second”, and “nth”, and quantities and an execution order are not limited either. The term “at least one” means one or more, and “a plurality of” means two or more. Information (including but not limited to user device information, user personal information, and the like), data (including but not limited to data for analysis, stored data, presented data, and the like), and signals may be authorized by a user or fully authorized by various parties, and collection, use, and processing of related data need to comply with relevant laws, regulations, and standards of relevant regions. For example, a virtual scene interface involved may be obtained with a full authority.

When a virtual scene is run, a player may control a controlled virtual object to attack a first virtual object, reducing hit points of the first virtual object, and implementing interaction between the virtual objects. However, the first virtual object generally can only be struck in situ. As a result, efficiency of interaction between the virtual objects may be low.

The following describes terms used herein.

Virtual scene may be a virtual scene that an application displays (or provides) when running on a terminal. The virtual scene may be a simulated environment of a real world, or may be a semi-simulated, semi-fictional virtual environment, or may be an entirely fictional virtual environment. In some examples, the virtual scene may be any one of a two-dimensional virtual scene, a 2.5-dimensional virtual scene, or a three-dimensional virtual scene, and dimensions of the virtual scene may be not limited in the examples described herein. For example, the virtual scene may include sky, land, and sea, and the land may include environmental elements such as a desert and a city. A user of the terminal may control a virtual object to move in the virtual scene.

Virtual object may be a movable object in a virtual world. The movable object may be at least one of a virtual character, a virtual animal, or a cartoon character. In some examples, when the virtual world is a three-dimensional virtual world, the virtual object may be a three-dimensional model, and each virtual object has its own shape and volume in the three-dimensional virtual world, and occupies some space in the three-dimensional virtual world. In some examples, the virtual object may be a three-dimensional character built based on a three-dimensional human skeleton technology. The virtual object shows different external images by wearing different skins. In some examples, the virtual object may alternatively be implemented by using a 2.5-dimensional model or a two-dimensional model. This is not limited in the examples of this application.

Open world: means that a scene in a virtual environment may be completely freely open. A virtual object may move and explore freely in any direction. Distances between boundaries in all directions may be extremely long. In addition, there may be various simulated objects of different shapes and sizes in the scene, which can cause various physical collisions or interactions with entities such as the virtual object.

Artificial intelligence (AI) may be a theory, method, technology, and application system that uses a digital computer or a machine controlled by a digital computer to simulate, extend, and expand human intelligence, perceive an environment, acquire knowledge, and use knowledge to obtain an optimal result. In other words, AI may be a comprehensive technology in computer science and attempts to understand the essence of intelligence and produce a new intelligent machine that can react in a manner similar to human intelligence. AI may be to study the design principles and example methods of various intelligent machines, to enable the machines to have the functions of perception, reasoning, and decision-making.

The following describes an example environment related to this application.

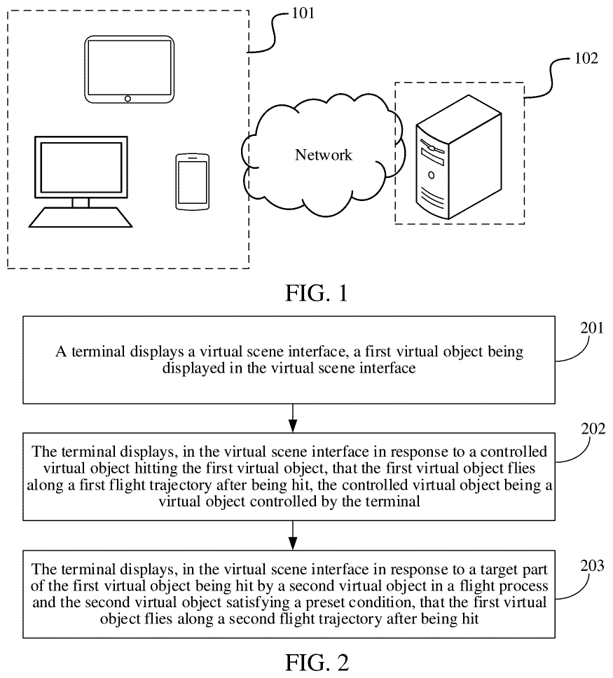

An interaction control method for virtual objects provided in the examples described herein can be performed by a computer device. The computer device may be a terminal or a server. The following describes a schematic diagram of an example environment of the interaction control method for virtual objects provided in the examples described herein. FIG. 1 is the schematic diagram of the example environment of the interaction control method for virtual objects. The example environment may include a terminal 101 and a server 102. The terminal 101 and the server 102 can be directly or indirectly connected through wired or wireless communication. In some examples, a target application running a virtual scene may be installed on the terminal 101, and the virtual scene may include a controlled virtual object controlled by the terminal 101 and a virtual object of an NPC type. The terminal 101 may be configured to control the controlled virtual object to interact with another virtual object. The terminal 101 may be configured to display an interaction effect. The server 102 may be a backend server of the target application, and may be configured to provide a backend service for running of the virtual scene. For example, the server 102 may be configured to provide a movement trajectory of the virtual object in the virtual scene. In some examples, the terminal 101 may also determine the movement trajectory of the virtual object in the virtual scene.

In some examples, the terminal 101 may be, but is not limited to, a smartphone, a tablet computer, a notebook computer, a desktop computer, a smart voice interaction device, a smart appliance, an in-vehicle terminal, an aircraft, a virtual reality (VR) apparatus, an augmented reality (AR) apparatus, or the like. In some examples, the server 102 may be an independent physical server, a server cluster or a distributed system including a plurality of servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and AI platform. In some examples, the server 102 may undertake primary computing work, and the terminal 101 may undertake secondary computing work. Alternatively, the server 102 may undertake a secondary computing service, and the terminal 101 may undertake primary computing work. Alternatively, a distributed computing architecture may be used between the server 102 and the terminal 101 for collaborative computing.

FIG. 2 is a flowchart of an interaction control method for virtual. The method may be performed by a computer device. In this example, the steps may be performed by a computer device which may be a terminal. The method includes the following operations.

201: The terminal displays a virtual scene interface, a first virtual object being displayed in the virtual scene interface.

In this example, the virtual scene interface may be an interface in a virtual scene, and the virtual scene includes a plurality of virtual objects. The plurality of virtual objects may include a controlled virtual object controlled by the terminal and a virtual object of an NPC type. The controlled virtual object completes a task by striking the virtual object of the NPC type. In this example, the first virtual object may be a virtual object of the NPC type. Further, the first virtual object may be an AI object. The AI object may be an object controlled via an AI module. In other words, the virtual object can be controlled, via the AI module, to perform various actions in the virtual scene.

202: The terminal displays, in the virtual scene interface in and response to the controlled virtual object hitting the first virtual object, that the first virtual object flies along a first flight trajectory after being hit, the controlled virtual object being a virtual object controlled by the terminal.

In this example, a perspective of the virtual scene may be a first-person perspective or a third-person perspective. In the first-person perspective, the controlled virtual object is not displayed in the virtual scene interface. In the third-person perspective, the controlled virtual object may be displayed in the virtual scene interface. To be specific, a camera in the virtual scene may be behind the controlled virtual object, and the controlled virtual object and an ambient environment of the controlled virtual object may be displayed in the virtual scene interface. In this example, the third-person perspective may be used as an example for description.

In this example, hitting may be in any one of the following interaction forms: hitting with a virtual prop or physical hitting. That the controlled virtual object physically hits the first virtual object means: The controlled virtual object may perform a physical attack action on the first virtual object. For example, the physical attack action may be striking. The controlled virtual object may strike the first virtual object, that is, the controlled virtual object hits the first virtual object.

In this example, the first virtual object not only may be hit by the controlled virtual object, but also may bump into the virtual object. That the first virtual object bumps into the virtual object means that physical contact may occur between the first virtual object and the virtual object due to a movement of either of the first virtual object and the virtual object. In other words, a bump occurs due to an unconscious touch, rather than the physical attack action.

203: The terminal displays, in the virtual scene interface in response to a target part of the first virtual object being hit by a second virtual object in a flight process and the second virtual object satisfying a preset condition, that the first virtual object flies along a second flight trajectory after being hit.

In some examples, the target part may be any part among at least one preset part, and the preset part includes the back, the thorax, and the like. Alternatively, the target part may be any part among at least one weak part, and the weak part includes the head, the neck, and the like. In some examples, different types of virtual objects have different weak parts, so that the different types of virtual objects have different target parts.

In this example, the first virtual object deviates from an original flight trajectory if being hit in the flight process. Correspondingly, the second flight trajectory may be a trajectory that deviates from the first flight trajectory.

This example may provide the interaction control method for virtual objects. The controlled virtual object may be controlled to hit the first virtual object, to trigger the first virtual object to fly after being hit, and after the target part of the first virtual object may be hit by a virtual object that satisfies the preset condition in the flight process, the first virtual object may be triggered to fly after being hit for the second time. In this way, as long as the controlled virtual object satisfies the preset condition, the controlled virtual object can interact with a flying virtual object, that is, the controlled virtual object can interact with the same first virtual object for a plurality of times. Therefore, an innovative playing method may be provided, efficiency of interaction with the first virtual object may be improved, and human-computer efficiency may be further improved. In addition, the first virtual object flies for a short time after being knocked down, and then the controlled virtual object triggers the first virtual object to fly after being hit for the second time, that is, the controlled virtual object hits the first virtual object for a plurality of times within a short time, so that the controlled virtual object interacts with the first virtual object for a plurality of times within a short time. Therefore, the efficiency of human-computer interaction may be further improved.

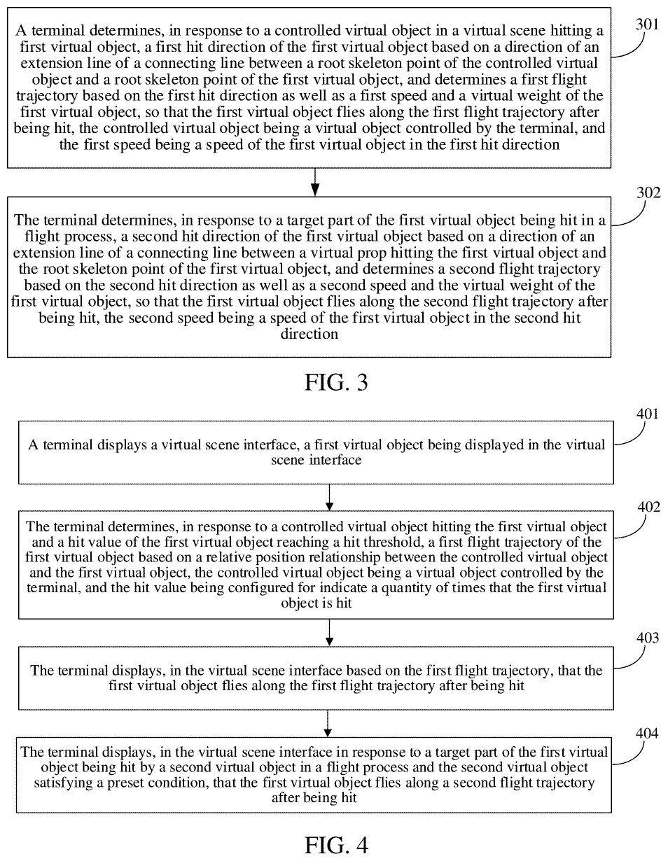

FIG. 2 shows representations of an interface for interaction control on virtual objects. The following describes, with reference to FIG. 3, a background process of interaction control on virtual objects. FIG. 3 is a flowchart of an interaction control method for virtual objects. The method may be performed by a computer device. The computer device may be a terminal or a server. In this example, the steps in FIG. 3 may be performed by the computer device which may be a terminal. The method includes the following operations.

301: The terminal determines, in response to a controlled virtual object in a virtual scene hitting a first virtual object, a first hit direction of the first virtual object based on a direction of an extension line of a connecting line between a root skeleton point of the controlled virtual object and a root skeleton point of the first virtual object, and determines a first flight trajectory based on the first hit direction as well as a first speed and a virtual weight of the first virtual object, so that the first virtual object flies along the first flight trajectory after being hit, the controlled virtual object being a virtual object controlled by the terminal, and the first speed being a speed of the first virtual object in the first hit direction.

In this example, that the terminal may determine the first hit direction of the first virtual object based on the direction of the extension line of the connecting line between the root skeleton point of the controlled virtual object and the root skeleton point of the first virtual object means: The terminal may use the direction of the extension line as the first hit direction.

In this example, the first speed may be in positive correlation with an attack intensity, an attack speed, and the like of the controlled virtual object, and may be in negative correlation with the virtual weight of the first virtual object. To be specific, a higher attack intensity, a higher attack speed, and a smaller virtual weight indicate a higher first speed.

In some examples, a process in which the terminal determines the first flight trajectory based on the first hit direction as well as the first speed and the virtual weight of the first virtual object may include the following operations: The terminal determines, based on the first hit direction and the first speed, a first horizontal speed and a first vertical speed of the first virtual object, the first horizontal speed and the first vertical speed being speeds of the first virtual object in a horizontal direction and a vertical direction, respectively. The terminal determines locations of the first virtual object at a plurality of first time points based on a first hit location, the first horizontal speed, the first vertical speed, and the virtual weight of the first virtual object, to obtain the first flight trajectory, the plurality of first time points including a time point at which the first virtual object reaches an end point of the first flight trajectory and a time point before the end point may be reached. In this example, speeds in the horizontal direction and the vertical direction may be first determined, and then displacements in the horizontal direction and the vertical direction in a flight process can be predicted. In this way, a plurality of locations in the flight process can be predicted, to obtain a flight trajectory. Therefore, appropriateness and accuracy of determining the flight trajectory may be improved.

In this example, a process in which the terminal determines the first horizontal speed and the first vertical speed of the first virtual object based on the first hit direction and the first speed may include the following operation: The terminal obtains an angle between the first hit direction and the horizontal direction and an angle between the first hit direction and the vertical direction, and decomposes the first speed to the horizontal direction and the vertical direction based on the angles, to obtain the first horizontal speed and the first vertical speed.

In some examples, the first virtual object may move at a constant speed in the horizontal direction, and move at a gravity acceleration in the vertical direction. Correspondingly, the terminal may determine, for each first time point, a time difference between the first time point and a time point at which the first virtual object may be hit, uses a product of the time difference and the first horizontal speed as a horizontal displacement at the first time point, and uses a sum of a horizontal coordinate of the first hit location of the first virtual object and the horizontal displacement as a horizontal coordinate corresponding to the first time point. The terminal determines a vertical displacement at the first time point based on the time difference, the first vertical speed, and the gravity acceleration, and uses a sum of a vertical coordinate of the first hit location of the first virtual object and the vertical displacement as a vertical coordinate corresponding to the first time point. In this way, location at the first time point may be obtained. The location includes the horizontal coordinate and the vertical coordinate that correspond to the first time point.

In this example, the locations at the plurality of first time points may be sorted in ascending order of the time points in the first flight trajectory, so that the first virtual object sequentially moves at the plurality of locations based on an order of the plurality of locations when flying along the first flight trajectory. A time interval between every two of the plurality of first time points may be set and changed as required.

302: The terminal determines, in response to a target part of the first virtual object being hit in the flight process, a second hit direction of the first virtual object based on a direction of an extension line of a connecting line between a virtual prop hitting the first virtual object and the root skeleton point of the first virtual object, and determines a second flight trajectory based on the second hit direction as well as a second speed and the virtual weight of the first virtual object, so that the first virtual object flies along the second flight trajectory after being hit, the second speed being a speed of the first virtual object in the second hit direction.

In this example, that the terminal determines the second hit direction of the first virtual object based on the direction of the extension line of the connecting line between the virtual prop hitting the first virtual object and the root skeleton point of the first virtual object means: The terminal uses the direction of the extension line as the second hit direction.

In this example, the second speed may be in correlation with the attack intensity, the attack speed, a prop type, the virtual weight of the first virtual object, and a speed of the first virtual object in the flight process.

In some examples, a process in which the terminal determines the second flight trajectory based on the second hit direction as well as the second speed and the virtual weight of the first virtual object includes the following operations: The terminal may determine, based on the second hit direction and the second speed, a second horizontal speed and a second vertical speed of the first virtual object, the second horizontal speed and the second vertical speed being speeds of the first virtual object in the horizontal direction and the vertical direction, respectively. The terminal may determine locations of the first virtual object at a plurality of second time points based on a second hit location, the second horizontal speed, the second vertical speed, and the virtual weight of the first virtual object, to obtain the second flight trajectory, the plurality of second time points including a time point at which the first virtual object reaches an end point of the second flight trajectory and a time point before the end point is reached. In this example, speeds in the horizontal direction and the vertical direction may be first determined, and then displacements in the horizontal direction and the vertical direction in a flight process can be predicted. In this way, a plurality of locations in the flight process can be predicted, to obtain a flight trajectory. Therefore, appropriateness and accuracy of determining the flight trajectory may be improved.

A process in which the terminal determines the second horizontal speed and the second vertical speed, and determines the locations at the plurality of second time points may be similar to operation 301, and details may be not described herein again.

In this example, a first knockdown direction may be determined based on the extension line of the connecting line between the root skeleton points of the two virtual objects, and then the first flight trajectory may be determined with reference to the speed and the virtual weight in this direction. The first flight trajectory determined in this way may conform to a physical principle and have high accuracy, so that a realistic flight effect can be presented when the first virtual object flies along the first flight trajectory. Similarly, the determined second flight trajectory may conform to the physical principle and has high accuracy, so that a realistic flight effect can be presented when the first virtual object flies along the second flight trajectory.

FIG. 2 shows a basic process of interaction control on virtual objects. FIG. 3 shows a process of determining a flight trajectory. The following further describes, with reference to FIG. 4, a process of interaction control on virtual objects. FIG. 4 is a flowchart of an interaction control method for virtual objects. The method may be performed by a computer device. In this example, an example in which the computer device may be a terminal is configured for description. The method includes the following operations.

401: The terminal displays a virtual scene interface, a first virtual object being displayed in the virtual scene interface.

In this example, when a perspective of the virtual scene may be a first-person perspective, no controlled virtual object may be displayed in the virtual scene interface. When the perspective of the virtual scene may be a third-person perspective, a controlled virtual object may be further displayed in the virtual scene interface. In this example, a virtual scene may be a virtual scene in an open world, the virtual scene interface may be an interface within a perspective of the controlled virtual object, and correspondingly, the first virtual object may be a virtual object within the perspective of the controlled virtual object.

402: The terminal determines, in response to the controlled virtual object hitting the first virtual object and a hit value of the first virtual object reaching a hit threshold, a first flight trajectory of the first virtual object based on a relative position relationship between the controlled virtual object and the first virtual object, the controlled virtual object being a virtual object controlled by the terminal, and the hit value being used to indicate a quantity of times that the first virtual object is hit.

In this example, the hit value may be a quantity of hits or a hit score. Correspondingly, when the hit value is the quantity of hits, the hit threshold may be a preset quantity of hits; or when the hit value is the hit score, the hit threshold may be a preset hit score. Each time the first virtual object may be hit, the hit value of the first virtual object may be adjusted once. When the hit value reaches the hit threshold, it indicates that the first virtual object reaches a condition for flying after being hit, and that the first virtual object flies after being hit may be displayed. In some examples, when the hit value is the quantity of hits, and the preset quantity of hits may be 1, the controlled virtual object needs to hit the first virtual object only once, and the terminal displays that the first virtual object flies after being hit.

In this example, when the hit value is the quantity of hits, the preset quantity of hits may be associated with at least one of a type of the first virtual object and a capability value of the controlled virtual object. Different types of virtual objects have different hit points. The capability value may be used to represent a hit point adjustment capability of the controlled virtual object for the first virtual object. A larger capability value of the controlled virtual object indicates a greater hit point loss caused to the first virtual object when the first virtual object may be hit, that is, a higher reduction amplitude of hit points of the first virtual object. In some examples, the preset quantity of hits may be associated with the type of the first virtual object, and correspondingly, the preset quantity of hits may be obtained from a correspondence between a type of a virtual object and a preset quantity of hits. Alternatively, the preset quantity of hits may be associated with the capability value of the controlled virtual object, and correspondingly, the preset quantity of hits may be obtained from a correspondence between a capability value of a controlled virtual object and a preset quantity of hits. Alternatively, the preset quantity of hits may be associated with the type of the first virtual object and the capability value of the controlled virtual object, and correspondingly, the preset quantity of hits may be obtained from a correspondence between a type of a virtual object, a capability value of a controlled virtual object, and a preset quantity of hits. In some examples, the preset quantity of hits may be alternatively associated with a type of a virtual prop used by the controlled virtual object. Hit points of the first virtual object may be adjusted by different amplitudes when the first virtual object may be hit by different types of virtual props. In some examples, the preset quantity of hits may be associated with the type of the virtual prop, and correspondingly, the preset quantity of hits may be obtained from a correspondence between a type of a virtual prop and a preset quantity of hits. Alternatively, the preset quantity of hits may be associated with the type of the virtual prop, and may be further associated with at least one of the type of the first virtual object and the capability value of the controlled virtual object, and correspondingly, the preset quantity of hits may be obtained from a correspondence between at least two of the associated items and the preset quantity of hits.

When the hit value is the hit score, the hit threshold may be the preset hit score, and each time the first virtual object may be hit, an adjustment amplitude of the hit score of the first virtual object may be associated with at least one of a type of the first virtual object, a capability value of the controlled virtual object, and a type of a virtual prop. In some examples, the adjustment amplitude may be associated with one of the type of the first virtual object, the capability value of the controlled virtual object, and the type of the virtual prop, and correspondingly, the adjustment amplitude may be obtained from a correspondence between this item and the adjustment amplitude. Alternatively, the adjustment amplitude may be associated with two of the type of the first virtual object, the capability value of the controlled virtual object, and the type of the virtual prop, and correspondingly, the adjustment amplitude may be obtained from a correspondence between the two items and the adjustment amplitude. Alternatively, the adjustment amplitude may be associated with the type of the first virtual object, the capability value of the controlled virtual object, and the type of the virtual prop, and correspondingly, the adjustment amplitude may be obtained from a correspondence between the three items and the adjustment amplitude.

In some examples, before the first virtual object may be hit by the controlled virtual object, the first virtual object can be hit by another controlled virtual object. In other words, the hit value of the first virtual object may be an accumulated hit value after the first virtual object may be hit by at least one controlled virtual object.

In this example, the hit value may be set for the first virtual object, so that the first virtual object can fly only after being hit for a plurality of times, implementing a mechanism of generating a particular knockdown effect for the first virtual object by introducing the hit value. In addition, because the adjustment amplitude of the hit score and the preset quantity of hits may be flexibly and dynamically determined based on the type of the first virtual object, the capability value of the controlled virtual object, and the type of the virtual prop, a probability a % that a virtual object flies each time being hit may be dynamically set.

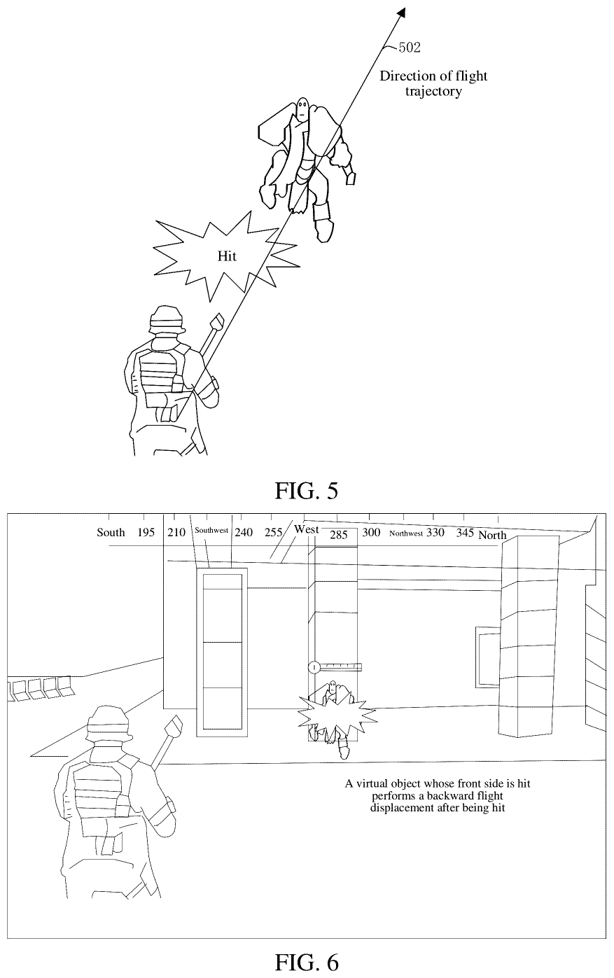

In some examples, that the terminal determines the first flight trajectory of the first virtual object based on the relative position relationship between the controlled virtual object and the first virtual object means: The terminal may determine an extension line of a connecting line between the controlled virtual object and the first virtual object, use a location at which the first virtual object may be hit as a start point of the first flight trajectory, and use a direction of the extension line as a direction of the first flight trajectory at the start point. The direction of the first flight trajectory at the start point may be the first hit direction of the first virtual object. In this example, the first flight trajectory may be determined based on the direction of the extension line of the connecting line between the two virtual objects, so that the flight trajectory matches the position relationship between the two virtual objects. Further, the flight trajectory may be flexibly and dynamically determined based on different position relationships. Therefore, the effect of flight based on the flight trajectory can be improved For example, FIG. 5 is a example schematic diagram of a hit direction 502.

In some examples, the connecting line between the controlled virtual object and the first virtual object may be a connecting line between root skeleton points of the two virtual objects or a connecting line between centers of gravity of the two virtual objects. When the connecting line between the controlled virtual object and the first virtual object is the connecting line between the root skeleton points of the two virtual objects, a process of determining the first flight trajectory based on the direction of the extension line of the connecting line may be similar to operation 301, and details may be not described herein again.

In this example, determining of the first flight trajectory may be driven by a program, and the foregoing operations may be described by using an example in which the terminal determines the first flight trajectory. In some other examples, the terminal determines the first flight trajectory via a server, and the server may be a backend server of a target application running the virtual scene. In some other examples, the terminal and the server respectively determine first flight trajectories. In this way, when the first flight trajectory determined by the terminal has an error, the first flight trajectory determined by the terminal can be adjusted in time based on the first flight trajectory determined by the server, to obtain an accurate first flight trajectory. Operation 402 may be merely an exemplary example of determining the first flight trajectory, and the first flight trajectory can alternatively be determined in another example. This may be not specifically limited herein. For example, a preset fixed flight trajectory may be used as the first flight trajectory.

403: The terminal displays, in the virtual scene interface based on the first flight trajectory, that the first virtual object flies along the first flight trajectory after being hit.

In some examples, that the terminal displays, in the virtual scene interface, that the first virtual object flies along the first flight trajectory after being hit includes the following operations: The terminal may determine, from a plurality of flight forms based on a hit side of the first virtual object, a target flight form matching the hit side, the plurality of flight forms corresponding to a plurality of sides of the first virtual object, and the flight form being a body form in the flight process. The terminal may display, in the virtual scene interface, that the first virtual object flies along the first flight trajectory in the target flight form.

In this example, the plurality of sides may be a front side, a back side, a left side, a right side, and the like of the first virtual object. The plurality of sides correspond to different flight forms. The plurality of flight forms may be set and modified as required. For example, when the hit side is the front side, the target flight form may be a form in which a body of the first virtual object bends backward. Correspondingly, that the first virtual object flies along the first flight trajectory in the target flight form means that the first virtual object flies backward along the first flight trajectory in the form in which the body bends backward. In this example, the flight form matching the hit side may be selected from the plurality of flight forms, so that diversity and efficiency of displaying the flight process may be improved, and a display effect may be further improved. In some examples, a flight form matching each side further includes a plurality of sub-forms, and the plurality of sub-forms respectively correspond to different hitting manners and hitting time. The terminal can further select a more accurate flight form from a plurality of sub-forms for the hit side in a manner in which the first virtual object may be hit and time at which the first virtual object may be hit.

In some examples, the flight process may be presented in a form of an animation. In some examples, the flight process includes a plurality of basic animations such as a knockdown start animation (KnockDown_Start), a knockdown loop animation (KnockDown_Loop), a knockdown end animation (KnockDown_End), and a knockdown bump animation (KnockDown_Bump). The knockdown start animation may be a flying-out animation displayed when the first virtual object may be triggered to be fly after being hit, and includes fight forms for the plurality of sides. A flight form used to form an animation as the knockdown start animation may be determined based on the hit side of the virtual object. The knockdown loop animation may be a loop flight animation of the virtual object in the flight process. The knockdown end animation may be an animation that the virtual object normally lands after flying. The knockdown bump animation may be an animation that the virtual object bumps into another virtual object or a virtual object in the flight process. For example, FIG. 6 is a schematic diagram of the flight process. If the first virtual object is hit by the controlled virtual object from the front side by using the virtual prop, the body of the first virtual object bends backward for a backward flight displacement.

In this example a landing point after the flight of the first virtual object may be to be located in an active region (navmesh) in the virtual scene. Correspondingly, when an end point of the first flight trajectory is located in an inactive region in the virtual scene, the terminal may adjust the end point of the first flight trajectory, so that an adjusted end point may be located in the active region in the virtual scene. When the end point of the first flight trajectory is located in the active region in the virtual scene, the end point of the first flight trajectory does not need to be adjusted. The end point of the first flight trajectory may be jointly determined based on an initial speed vector of the first virtual object when the first virtual object flies after being hit and a physical effect of gravity. To be specific, a parabolic calculation may be performed by using the initial speed vector and the weight of the first virtual object, to obtain the first flight trajectory. In this example, the landing point may be controlled to be located in the active region in the virtual scene, to avoid sticking of the virtual object flying after being hit after being hit at some locations in the virtual scene at which the virtual object cannot move.

In some examples, a process of adjusting the end point of the first flight trajectory includes the following operation: using a location in the active region that may be closest to the end point of the first flight trajectory as the adjusted end point. In some examples, when there are a plurality of locations in the active region that are closest to the end point of the first flight trajectory, a location among the plurality of locations that is located right below the first flight trajectory may be used as the adjusted end point, so that the end point matches the flight trajectory. In this example, the end point of the first flight trajectory may be adjusted, so that the landing point of the virtual object may be located in the active region. In addition, the adjusted end point matches the first flight trajectory. Therefore, reliability and accuracy of the adjusted end point may be improved. Correspondingly, the terminal displays, in the virtual scene interface based on the first flight trajectory and the adjusted end point, that the first virtual object flies along the first flight trajectory after being hit.

In some examples, the virtual scene includes a virtual object that may be allowed to fly after being hit and a virtual object that may be not allowed to fly after being hit. In some examples, the virtual object that may be not allowed to fly after being hit may be marked with a first identifier (tag), and the first identifier indicates that the virtual object may be not allowed to fly after being hit. In some examples, when the controlled virtual object hits the first virtual object, whether the first virtual object carries the first identifier may be detected. If the first virtual object does not carry the first identifier, the foregoing operations 402 and 403 may be performed; or if the first virtual object carries the first identifier, when the first virtual object may be hit by the controlled virtual object, the hit value may be not accumulated, and correspondingly, the first virtual object may be not triggered to fly.

404: The terminal displays, in the virtual scene interface in response to a target part of the first virtual object being hit by a second virtual object in the flight process and the second virtual object satisfying a preset condition, that the first virtual object flies along a second flight trajectory after being hit.

In this example, a flying virtual object usually does not trigger a new flight. To improve diversity of playing methods in the virtual scene, a playing method in which the first virtual object in the flight process can fly after being hit for the second time may be set through perk correction.

In this example, that the second virtual object satisfies the preset condition includes at least one of the following: a capability value of the second virtual object satisfies a preset capability value; or a virtual prop used by the second virtual object may be a preset prop. The preset capability value and the preset prop may be set and changed as required. This may be not specifically limited herein. In this example, a restriction for triggering flight after a second hit may be set, to help a user to improve the capability value of the controlled virtual object and obtain the preset prop, helping the user to participate in the virtual scene.

In some other examples, the terminal displays, in the virtual scene interface in response to the target part of the first virtual object being hit by the second virtual object in the flight process, the second virtual object satisfying the preset condition, and the first virtual object being a virtual object allowed to fly after being hit for the second time, that the first virtual object flies along the second flight trajectory after being hit. In this example, different playing methods of flying after hits may be set for different virtual objects, so that the diversity of the playing methods may be improved, and interaction diversity may be further improved.

In this example, the second flight trajectory may be determined based on a relative position relationship between the first virtual object and the second virtual object. In some examples, a process of determining the second flight trajectory may be similar to the process of determining the first flight trajectory in operation 402, and details may be not described herein again. In some other examples, the second flight trajectory may be determined based on a direction of an extension line of a connecting line between the root skeleton point of the first virtual object and the virtual prop hitting the first virtual object. The process may be similar to operation 302, and details may be not described herein again.

In some examples, when an end point of the second flight trajectory may be located in the inactive region in the virtual scene, the terminal adjusts the end point of the second flight trajectory, so that an adjusted end point may be located in the active region in the virtual scene. A process of adjusting the end point of the second flight trajectory may be similar to the process of adjusting the end point of the first flight trajectory in operation 403, and details may be not described herein again.

In some examples, the terminal determines, in response to the target part of the first virtual object being hit by the second virtual object in the flight process and the second virtual object satisfying the preset condition, a hit point adjustment ratio of the first virtual object based on the capability value of the second virtual object, and adjusts hit points of the first virtual object based on the hit point adjustment ratio of the first virtual object, the hit point adjustment ratio of the first virtual object being in positive correlation with the capability value of the second virtual object.

In this example, adjusting the hit points of the first virtual object means reducing the hit points of the first virtual object. Adjusting the hit points of the first virtual object based on the hit point adjustment ratio (n %) of the first virtual object means determining a product between the hit points of the first virtual object and the hit point adjustment ratio, and using a difference between the hit points of the first virtual object and the product as adjusted hit points.

Correspondingly, when the hit points of the first virtual object may be not adjusted to a threshold, the terminal displays, in the virtual scene interface, that the first virtual object flies along the second flight trajectory after being hit; and when the hit points of the first virtual object may be adjusted to the threshold, displays, in the virtual scene interface, that the first virtual object may be eliminated.

In an example, that the terminal determines the hit point adjustment ratio of the first virtual object based on the capability value of the second virtual object means that the terminal determines the hit point adjustment ratio of the first virtual object based on the capability value of the second virtual object and a type of the first virtual object. In some examples, a process in which the terminal determines the hit point adjustment ratio of the first virtual object based on the capability value of the second virtual object and the type of the first virtual object includes the following operations: The terminal determines, from a plurality of correspondences based on the type of the first virtual object, a target correspondence corresponding to the type, the plurality of correspondences corresponding to a plurality of types of virtual objects. The terminal determines, from the target correspondence, the hit point adjustment ratio corresponding to the capability value of the second virtual object, the target correspondence including hit point adjustment ratios respectively corresponding to a plurality of capability values. In this example, the hit point adjustment ratio may be determined based on the capability value of the second virtual object and the type of the first virtual object, so that the hit point adjustment ratio may be flexibly and dynamically determined. Therefore, the determined hit point adjustment ratio may be more accurate, and the hit points can be accurately adjusted.

In this example, the threshold may be a zero value. Displaying, in the virtual scene interface, that the first virtual object may be eliminated may be displaying, in the virtual scene interface that, the first virtual object immediately disappears, or gradually disappears, or becomes larger and then disappears, to improve the display effect.

In this example, a virtual object has a thick basic armor by default. When the controlled virtual object hits the virtual object, to trigger the virtual object to fly after being hit for the first time, hit points of the virtual object may be slightly reduced or not reduced. However, hitting the virtual object in the flight process not only triggers the virtual object to fly after being hit for the second time, but also can reduce the hit points of the virtual object to a large extent. In other words, an adjustment amount of the hit points during flight after the second hit may be much greater than that of the hit points during flight after the first hit. This can help the controlled virtual object interact with the virtual object in flight, to quickly reduce the hit points of the virtual object by hitting the virtual object in flight, and improve efficiency of interaction with the virtual object, improving human-computer efficiency.

In this example, to implement flight after the second hit, the target part of the first virtual object needs to be hit, and a virtual object that hits the first virtual object needs to satisfy the preset condition. In other words, compared with flight after the first hit, flight after the second hit may be more difficult to implement, and has a greater threshold. Correspondingly, a hit point adjustment amount in a flight process after the second hit may be increased, so that difficulty matches the hit point adjustment amount, which can facilitate interaction between the controlled virtual object and the virtual object in flight, and improve the efficiency of human-computer interaction.

This example provides the interaction control method for virtual objects. The controlled virtual object may be controlled to hit the first virtual object, to trigger the first virtual object to fly after being hit, and after the target part of the first virtual object may be hit by a virtual object that satisfies the preset condition in the flight process, the first virtual object may be triggered to fly after being hit for the second time. In this way, as long as the controlled virtual object satisfies the preset condition, the controlled virtual object can interact with a flying virtual object, that is, the controlled virtual object can interact with the same first virtual object for a plurality of times. Therefore, an innovative playing method may be provided, efficiency of interaction with the first virtual object may be improved, and human-computer efficiency may be further improved. In addition, the first virtual object flies for a short time after being knocked down, and then the controlled virtual object triggers the first virtual object to fly after being hit for the second time, that is, the controlled virtual object hits the first virtual object for a plurality of times within a short time, so that the controlled virtual object interacts with the first virtual object for a plurality of times within a short time. Therefore, the efficiency of human-computer interaction may be further improved.

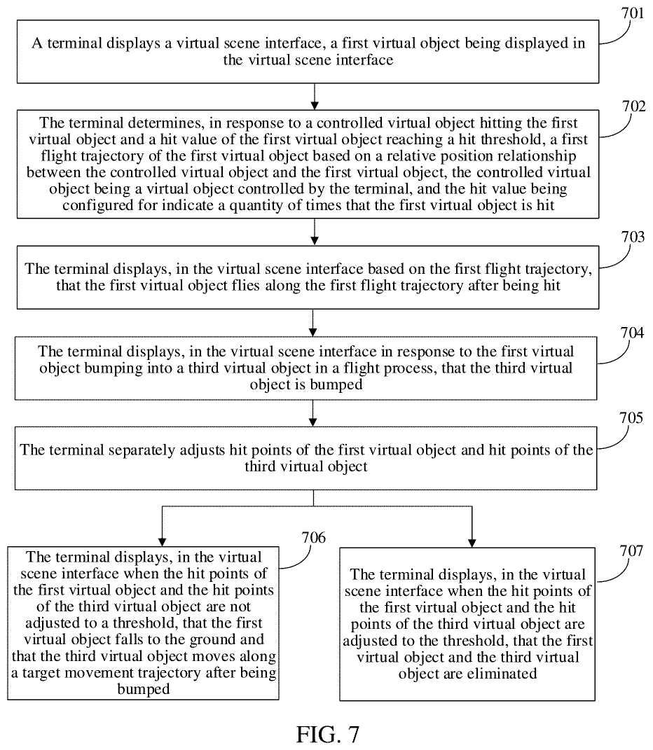

FIG. 4 is described only by using an interaction process in which a flying virtual object flies after being hit for the second time as an example. The flying virtual object can further perform bump interaction with another virtual object. The following describes the process in detail with reference to FIG. 7. FIG. 7 is a flowchart of an interaction control method for virtual objects. The method may be performed by a computer device. In this example, an example in which the computer device may be a terminal is configured for description. The method includes the following operations.

701: The terminal displays a virtual scene interface, a first virtual object being displayed in the virtual scene interface.

702: The terminal determines, in response to a controlled virtual object hitting the first virtual object and a hit value of the first virtual object reaching a hit threshold, a first flight trajectory of the first virtual object based on a relative position relationship between the controlled virtual object and the first virtual object, the controlled virtual object being a virtual object controlled by the terminal, and the hit value being used to indicate a quantity of times that the first virtual object may be hit.

703: The terminal displays, in the virtual scene interface based on the first flight trajectory, that the first virtual object flies along the first flight trajectory after being hit.

In this example, operations 701 to 703 may be similar to operations 401 to 403. Details are not described herein again.

704: The terminal displays, in the virtual scene interface in response to the first virtual object bumping into a third virtual object in a flight process, that the third virtual object may be bumped.

In this example, the third virtual object may be a virtual object of an NPC type. The first virtual object bumps into at least one third virtual object. In other words, the first virtual object can bump into at least one third virtual object in one bump process.

In this example, a location at which the first virtual object bumps into the third virtual object can be in the air or on the ground. For example, a flying third virtual object may be bumped in the air, or a third virtual object on the ground may be bumped on the ground.

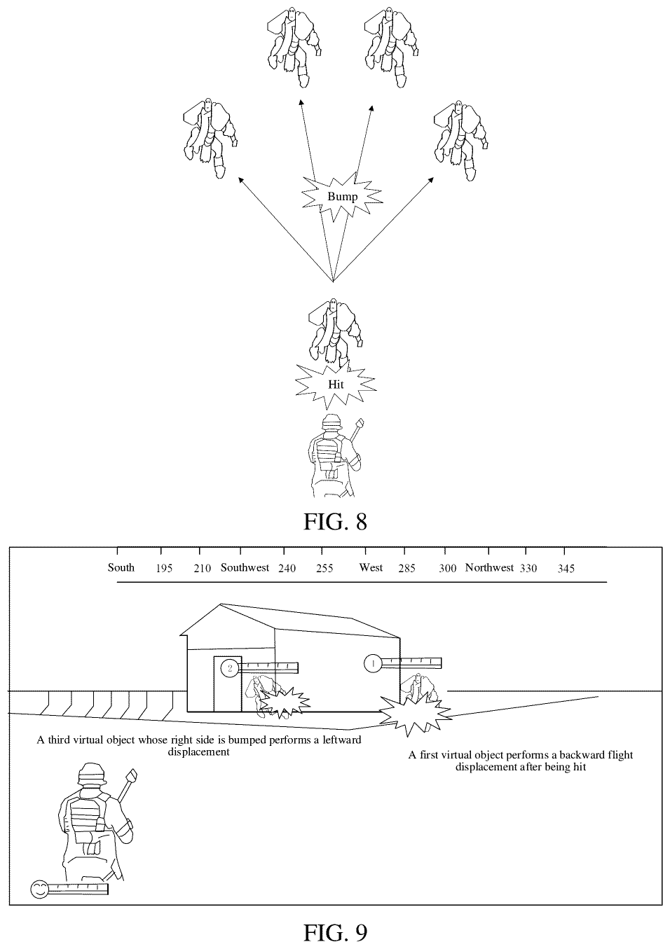

In this example, the first virtual object can bump into a plurality of third virtual objects in one bump process. In some examples, the plurality of third virtual objects may be virtual objects in physical contact with the first virtual object. Alternatively, the plurality of third virtual objects may be virtual objects within a preset range, the preset range using the 1st third virtual object that the first virtual object bumps into as a center and using a preset distance as a radius. In other words, bumping into any virtual object may trigger a chain reaction of bumping into surrounding virtual objects, so that the first virtual object bumps into a plurality of virtual objects at a time. For example, FIG. 8 may be a schematic diagram of bumping into a virtual object. After the first virtual object may be hit by the controlled virtual object, the first virtual object may be triggered to fly, and the first virtual object can bump into a plurality of third virtual objects at a time in the flight process.

In this example, a virtual scene may include a virtual object allowed to be bumped and a virtual object not allowed to be bumped. In some examples, the virtual object not allowed to be bumped may be marked with a third identifier, and the third identifier indicates that the virtual object may be not allowed to be bumped. In some examples, when the third virtual object may be bumped, the terminal detects whether the third virtual object carries the third identifier. If the third virtual object does not carry the third identifier, operation 704 may be performed; or if the third virtual object carries the third identifier, it may be not displayed that the third virtual object may be bumped, hit points of the third virtual object may be not adjusted, and only hit points of the first virtual object may be adjusted.

This example provides the interaction control method for virtual objects. The controlled virtual object may be controlled to hit the first virtual object, and when the hit value of the first virtual object reaches the hit threshold, the first virtual object may be triggered to fly after being hit, and the first virtual object can bump into another virtual object in the flight process. In other words, in an interaction manner provided in the method, one attack of the controlled virtual object can trigger chain reactions of flight after hits and bumping into virtual objects, so that an actual effect generated by one attack may be greater than an effect generated by the attack, expanding an attack range, and further improving efficiency of human-computer interaction.

705: The terminal separately adjusts the hit points of the first virtual object and the hit points of the third virtual object.

In some examples, a hit point adjustment ratio of a virtual object may be associated with a capability value of the controlled virtual object and a type of the virtual object. Correspondingly, a process in which the terminal separately adjusts the hit points of the first virtual object and the hit points of the third virtual object may include the following operations: The terminal determines a hit point adjustment ratio of the first virtual object based on the capability value of the controlled virtual object, and adjusts the hit points of the first virtual object based on the hit point adjustment ratio of the first virtual object, the hit point adjustment ratio of the first virtual object being in positive correlation with the capability value of the controlled virtual object. The terminal determines a hit point adjustment ratio of the third virtual object based on the capability value of the controlled virtual object, and adjusts the hit points of the third virtual object based on the hit point adjustment ratio of the third virtual object, the hit point adjustment ratio of the third virtual object being in positive correlation with the capability value of the controlled virtual object.

In this example, adjusting the hit points of the first virtual object and the hit points of the third virtual object means reducing the hit points of the first virtual object and the hit points of the third virtual object. For either of the first virtual object and the third virtual object, adjusting the hit points of the virtual object based on the hit point adjustment ratio (n %) of the virtual object means determining a product between the hit points of the virtual object and the hit point adjustment ratio, and using a difference between the hit points of the virtual object and the product as adjusted hit points.

In this example, that the hit point adjustment ratio of the virtual object may be in positive correlation with the capability value of the controlled virtual object means that for virtual objects of a same type, a larger capability value of the controlled virtual object corresponds to a larger hit point adjustment ratio.

In some examples, for any virtual object, the terminal further may determine a hit point adjustment ratio of the virtual object based on a type of the virtual object. For either of the first virtual object and the third virtual object, a process in which the terminal determines the hit point adjustment ratio of the virtual object based on the capability value of the controlled virtual object and the type of the virtual object includes the following operations: The terminal determines, from a plurality of correspondences based on the type of the virtual object, a target correspondence corresponding to the type, the plurality of correspondences corresponding to a plurality of types of virtual objects. The terminal determines, from the target correspondence, the hit point adjustment ratio corresponding to the capability value of the controlled virtual object, the target correspondence including hit point adjustment ratios respectively corresponding to a plurality of capability values. In this example, the hit point adjustment ratio may be determined based on the capability value of the controlled virtual object and the type of the virtual object, so that the hit point adjustment ratio may be flexibly and dynamically determined. Therefore, the determined hit point adjustment ratio may be more accurate, and the hit points can be accurately adjusted.

In this example, a virtual object has a thick basic armor by default. After the controlled virtual object hits the virtual object, hit points of the virtual object may be slightly reduced or not reduced. However, bumping into the virtual object can reduce the hit points of the virtual object to a large extent. This can help the controlled virtual object hit the virtual object to trigger the virtual object to fly, so that the flying virtual object bumps into another virtual object, to quickly reduce hit points of the virtual object.

In some examples, the terminal adjusts the hit points of the first virtual object not only after the first virtual object bumps into the third virtual object in the flight process, but also after the first virtual object bumps into any virtual object in the virtual scene. For example, the terminal displays, in the virtual scene interface in response to the first virtual object bumping into a wall in the virtual scene in the flight process, that the first virtual object bumps into the wall, and adjusts the hit points of the first virtual object.

In some examples, the bumped third virtual object does not bump into another virtual object, so that simplicity of a bump playing method may be improved. In some other examples, the bumped third virtual object can further bump into another surrounding virtual object, to trigger a bump chain reaction, so that a bump interaction effect may be improved.

706: The terminal displays, in the virtual scene interface when the hit points of the first virtual object and the hit points of the third virtual object may be not adjusted to the threshold, that the first virtual object falls to the ground and that the third virtual object moves along a target movement trajectory after being bumped.

In some examples, the first virtual object falls to the ground in the following several manners: The first virtual object vertically falls to the ground at the bump location. Alternatively, the first virtual object changes a flight trajectory at the bump location, and falls to the ground along a changed flight trajectory. After bumping into the third virtual object, the first virtual object vertically falls to the ground when kinetic energy may be completely consumed. The first virtual object changes the flight trajectory when obtaining new kinetic energy in a process of bumping into the third virtual object. In some examples, a direction of the changed flight trajectory may be opposite to a direction of the first flight trajectory.

When the location at which the first virtual object bumps into the third virtual object may be in the air, that the third virtual object moves along the target movement trajectory after being bumped means that the third virtual object vertically falls to the ground at the bump location. Alternatively, the third virtual object changes a flight trajectory at the location at which the third virtual object may be bumped, the target movement trajectory may be a changed flight trajectory, and that the third virtual object moves along the target movement trajectory after being bumped means falling to the ground along the changed flight trajectory. An example process may be the same as the foregoing process in which the first virtual object falls to the ground, and details may be not described herein again.

When the location at which the first virtual object bumps into the third virtual object may be on the ground, that the third virtual object moves along the target movement trajectory after being bumped means that the third virtual object moves along the target movement trajectory on the ground after being bumped. Correspondingly, a process of determining the target movement trajectory includes the following operation: The terminal determines, based on a flight orientation of the first virtual object relative to the third virtual object, the target movement trajectory of the third virtual object after the third virtual object may be bumped. The flight orientation may be the same as a direction in which the first virtual object flies toward the third virtual object. For example, if the first virtual object flies toward the third virtual object from the left of the third virtual object, the flight orientation of the first virtual object relative to the third virtual object may be a left-to-right direction.

In some examples, a process in which the terminal determines the target movement trajectory based on the flight orientation includes the following operation: The terminal performs extension by a preset distance along the flight orientation by using the location at which the third virtual object may be bumped as a start point, to obtain the target movement trajectory. The preset distance may be set and changed as required. In some examples, the preset distance may be a fixed distance. In this example, determining the target movement trajectory in such a manner achieves an effect that the third virtual object may be bumped to stumble for a few steps when the third virtual object moves along the target movement trajectory, thereby improving the bump display effect. In addition, a movement trajectory may be directly determined by using the preset distance, without predetermining a falling point, and a displacement may be directly driven, so that bump display efficiency may be improved. In some examples, the movement trajectory may be determined by a root motion model built in the terminal, so that determining efficiency may be improved.

In some examples, when the bumped third virtual object may be bumped and the hit points may be not adjusted to the threshold, the third virtual object may be displayed to move after being bumped. In some other examples, the third virtual object has a bump value, and the bump value may be used to indicate a quantity of times that the third virtual object may be bumped. Correspondingly, after the first virtual object bumps into the third virtual object on the ground, and the bump value of the third virtual object reaches a bump threshold, it may be displayed in the virtual scene interface that the third virtual object moves along the target movement trajectory after being bumped, and the bump value may be adjusted after the third virtual object may be bumped. When the bump value of the third virtual object does not reach the bump threshold, it may be displayed that the third virtual object may be bumped rather than the third virtual object moves after being bumped. In some examples, the bump value may be an accumulated bump value after the third virtual object may be bumped by at least one first virtual object.

The bump value may be a quantity of bumps or a bump score. Correspondingly, when the bump value may be the quantity of bumps, the bump threshold may be a preset quantity of bumps; or when the bump value may be the bump score, the bump threshold may be a preset bump score. Each time the third virtual object may be bumped, the bump value of the third virtual object may be adjusted once.

When the bump value may be the quantity of bumps, the preset quantity of bumps may be associated with one of a weight of the third virtual object and a weight of the first virtual object, and correspondingly, the preset quantity of bumps can be obtained from a correspondence between this item and the preset quantity of bumps. Alternatively, the preset quantity of bumps may be associated with both a weight of the third virtual object and a weight of the first virtual object, and correspondingly, the preset quantity of bumps can be obtained from a correspondence between the two items and the preset quantity of bumps. When the bump value may be the bump score, in some examples, an adjustment amplitude of the bump score may be associated with one of a weight of the third virtual object and a weight of the first virtual object, and correspondingly, the adjustment amplitude can be obtained from a correspondence between this item and the adjustment amplitude. Alternatively, an adjustment amplitude may be associated with both a weight of the third virtual object and a weight of the first virtual object, and correspondingly, the adjustment amplitude can be obtained from a correspondence between the two items and the adjustment amplitude.

In some examples, a process in which the terminal displays, in the virtual scene interface, that the third virtual object moves along the target movement trajectory after being bumped includes the following operations: The terminal determines, from a plurality of bumped forms based on a bumped side of the third virtual object, a target bumped form matching the bumped side, the plurality of bumped forms corresponding to a plurality of sides of the third virtual object, and the bumped form being a body form of the third virtual object after the third virtual object may be bumped. The terminal displays, in the virtual scene interface based on the target bumped form, that the third virtual object moves along the target movement trajectory in the target bumped form. In this example, the bumped form matching the bumped side may be selected from the plurality of bumped forms, so that diversity and efficiency of displaying the bump process may be improved, and a display effect of the bump process may be further improved.

In this example, the plurality of sides may be a front side, a back side, a left side, a right side, and the like of the third virtual object that may be bumped, and can be set and modified as required. For example, the plurality of sides may be the front side, the back side, the left side, and the right side, and correspondingly, a plurality of bumped forms corresponding to a plurality of directions may be respectively named Bump_F, Bump_B, Bump_L, and Bump_R. The plurality of bumped forms can be set and changed as required. For example, if the bumped side may be the front side, the target bumped form may be a form in which the third virtual object leans backward, and correspondingly, that the third virtual object moves along the target movement trajectory in the target bumped form means that the third virtual object moves backward along the target movement trajectory in the form of leaning backward. For example, FIG. 9 is a schematic diagram of bumping into a virtual object. The controlled virtual object hits the front side of the first virtual object, and the first virtual object performs a backward flight displacement after being hit. The right side of the third virtual object may be bumped, and the third virtual object performs a leftward displacement after being bumped.

When the hit points of the third virtual object are not reduced to the threshold, the target movement trajectory may be determined, and it may be displayed that the third virtual object moves along the target movement trajectory after being bumped. Correspondingly, when the hit points of the third virtual object are reduced to the threshold, it may be displayed that the third virtual object may be eliminated after being bumped.

707: The terminal displays, in the virtual scene interface when the hit points of the first virtual object and the hit points of the third virtual object are adjusted to the threshold, that the first virtual object and the third virtual object are eliminated.

When the hit points of the first virtual object are adjusted to the threshold, and the hit points of the third virtual object are not adjusted to the threshold, the terminal displays, in the virtual scene interface, that the first virtual object may be eliminated and that the third virtual object moves along a target movement trajectory after being bumped. When the hit points of the first virtual object are not adjusted to the threshold, and the hit points of the third virtual object are adjusted to the threshold, the terminal displays, in the virtual scene interface, that the third virtual object may be eliminated and that the first virtual object falls to the ground.

The threshold may be a zero value. In some examples, displaying, in the virtual scene interface, that the first virtual object and the third virtual object eliminated may be displaying, in the virtual scene interface that, the first virtual object and the third virtual object immediately disappear, or gradually disappear, or become larger and then disappear, to improve the display effect.

When the first virtual object does not bump into another virtual object in the flight process, it may be displayed that the first virtual object lands at an end point of the first flight trajectory along the first flight trajectory. In some examples, the terminal adjusts the hit points of the first virtual object after the first virtual object bumps into the ground. The process may be the same as the adjustment process in operation 705, and details may be not described herein again. When the hit points of the first virtual object are adjusted to the threshold, it may be displayed in the virtual scene interface that the first virtual object may be eliminated at the end point; or when the hit points of the first virtual object are not adjusted to the threshold, it may be displayed in the virtual scene interface that the first virtual object gets up and returns to a walking form after landing at the end point.

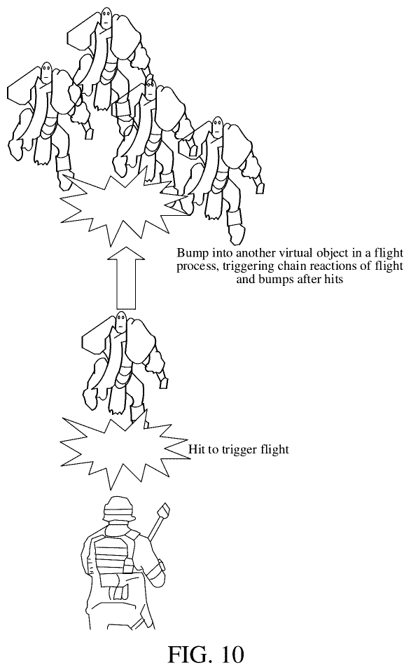

The first virtual object can bump into the at least one third virtual object in the flight process. Because hit points of all bumped virtual objects may be adjusted, correspondingly, the controlled virtual object can gather a plurality of virtual objects together through movement, and then hit one first virtual object, so that the first virtual object bumps into the plurality of third virtual objects that may be gathered together at a time. In this way, the controlled virtual object can interact with a plurality of virtual objects at the same time, and hit points of the plurality of virtual objects can be reduced. Therefore, interaction efficiency may be improved, and refreshing playing experience may be provided. For example, FIG. 10 is a schematic diagram of interaction between virtual objects. The controlled virtual object hits the first virtual object, to trigger the first virtual object to fly, and the first virtual object bumps into a plurality of third virtual objects in the flight process. In this way, the controlled virtual object may be controlled to implement chain reactions of flight and bumps after hits, so that diversity and interaction efficiency of an interactive playing method may be improved.

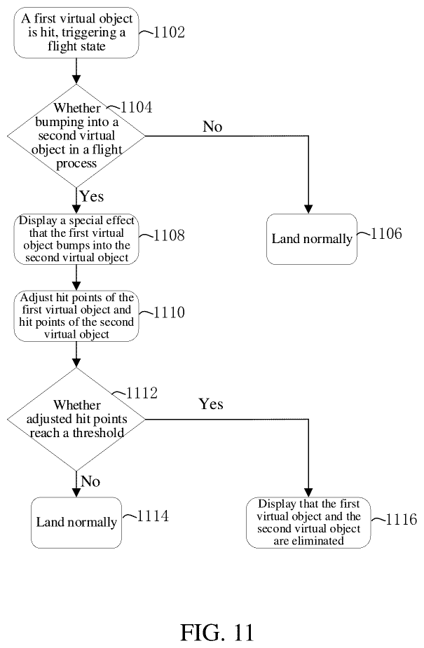

FIG. 11 may be a flowchart of an interaction control method for virtual objects. Two types of data, that is, a probability that a virtual object flies each time being hit and a hit point adjustment ratio, may be packed and named “pinball table” for subsequent use. Correspondingly, if a single game includes a “pinball person” corresponding to a “pinball table”, the first virtual object may be hit to trigger a flight state at step 1102, and then whether the first virtual object bumps into the second virtual object in the flight process may be detected at step 1104. If the second virtual object is not bumped, it may be displayed that the first virtual object normally lands at step 1106; or if the second virtual object is bumped, a special effect that the first virtual object bumps into the second virtual object may be displayed at step 1108, the hit points of the first virtual object and the hit points of the second virtual object may be adjusted at step 1110, and whether the adjusted hit points reach the threshold may be determined at step 1112. If the adjusted hit points do not reach the threshold, it may be displayed that the first virtual object and the second virtual object normally land at step 1114; or if the adjusted hit points reach the threshold, it may be displayed that the first virtual object and the third virtual object may be eliminated at step 1116.

The controlled virtual object may be controlled to hit the first virtual object, and when the hit value of the first virtual object reaches the hit threshold, the first virtual object may be triggered to fly after being hit, and the first virtual object can bump into another virtual object in the flight process. In other words, in an interaction manner provided in the method, one attack of the controlled virtual object can trigger chain reactions of flight after hits and bumping into virtual objects, so that an actual effect generated by one attack may be greater than an effect generated by the attack, expanding an attack range, and further improving efficiency of human-computer interaction.

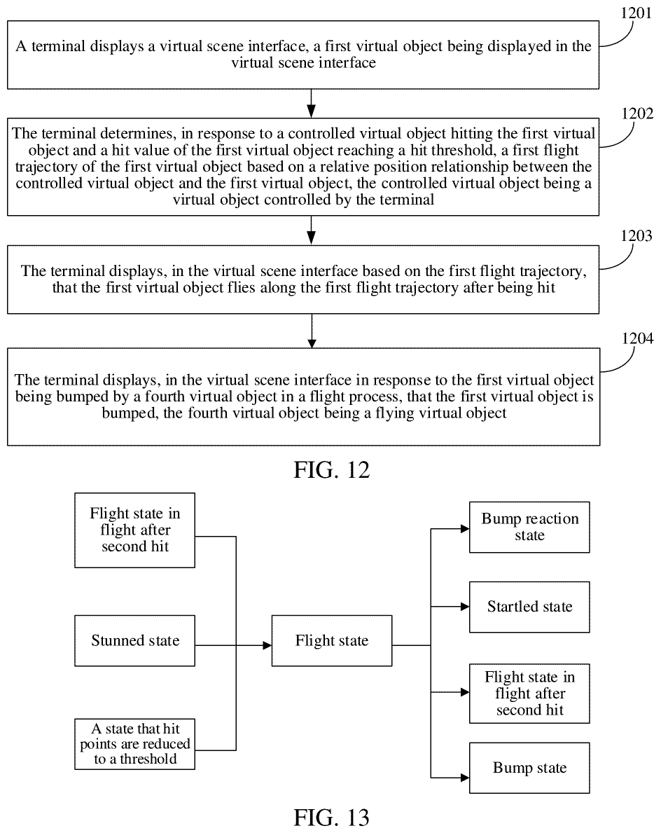

The example in FIG. 7 may be described only by using an interaction process in which a flying virtual object bumps into another virtual object as an example. The flying virtual object can further interact with another flying virtual object. The following describes the process in detail with reference to FIG. 12. FIG. 12 is a flowchart of an interaction control method for virtual objects. The method may be performed by a computer device. The computer device may be a terminal device. The method includes the following operations.

1201: The terminal displays a virtual scene interface, a first virtual object being displayed in the virtual scene interface.

1202: The terminal determines, in response to a controlled virtual object hitting the first virtual object and a hit value of the first virtual object reaching a hit threshold, a first flight trajectory of the first virtual object based on a relative position relationship between the controlled virtual object and the first virtual object, the controlled virtual object being a virtual object controlled by the terminal.

1203: The terminal displays, in the virtual scene interface based on the first flight trajectory, that the first virtual object flies along the first flight trajectory after being hit.

Operations 1201 to 1203 may be similar to operations 401 to 403. Details are not described herein again.

1204: The terminal displays, in the virtual scene interface in response to the first virtual object being bumped by a fourth virtual object in the flight process, that the first virtual object is bumped, the fourth virtual object being a flying virtual object.

In this example, after the first virtual object is bumped by the fourth virtual object, the terminal adjusts hit points of the first virtual object and hit points of the fourth virtual object. When the hit points of the first virtual object and the hit points of the fourth virtual object may be not reduced to a threshold, that the terminal displays, in the virtual scene interface, that the first virtual object may be bumped includes the following operation: The terminal displays, in the virtual scene interface, that the first virtual object and the fourth virtual object fall to the ground after bumping into each other. An example process of falling to the ground may be similar to operation 706, and details may be not described herein again. When the hit points of the first virtual object and the hit points of the fourth virtual object may be reduced to a threshold, that the terminal displays, in the virtual scene interface, that the first virtual object may be bumped includes the following operation: The terminal displays, in the virtual scene interface, that the first virtual object and the fourth virtual object may be eliminated after bumping into each other. This may be similar to operation 707, and details may be not described herein again. Two flying virtual objects can perform bump interaction, so that interaction diversity may be improved, and interaction efficiency may be improved.

Because two flying virtual objects can perform bump interaction, with hit points reduced, the controlled virtual object can be helped to hit a plurality of virtual objects, to trigger the plurality of virtual objects to fly after being hit, to reduce hit points of the virtual objects at the same time through bump interaction between the flying virtual objects, improve the interaction efficiency, and provide refreshing playing experience.

A status of a virtual object includes a flight state, a bump state, a startled state, a hit state, a stunned state (weak stun), a state that hit points may be reduced to the threshold, and the like. The bump state includes a moment at which the virtual object may be bumped and a state (hit reaction) that a movement occurs after the bump. The startled state may be a state that the virtual object may be startled by some virtual props, for example, a state that the virtual object may be startled by a sound-and-light prop. The stunned state may be a state after the virtual object may be struck. The flight state includes a flight state in flight after a first hit and a flight state in flight (perk) after a second hit. Any state can interrupt another state, or can be interrupted by another state. For example, the terminal displays, in the virtual scene interface in response to the first virtual object being hit while in a first state and the hit value reaching the hit threshold, that the first virtual object flies along the first flight trajectory after being hit, the first state including the bump state, the flight state, or the startled state. The terminal stops the flight process in response to the first virtual object reaching a second state in the flight process, the second state including the hit state, the stunned state, or the state that the hit points may be reduced to the threshold. It may be set that a plurality of states can be interrupted by each other, and a state usually occurs due to interaction between virtual objects. In this way, a plurality of interaction situations can be implemented, improving diversity of interaction between virtual objects, and improving interaction efficiency.

A state that can be interrupted by any state and a state that can interrupt the any state may be determined by priorities of the plurality of states. A higher priority indicates that the any state can interrupt more states. The foregoing several states and an interruption priorities of the several states may be merely an exemplary description. In different virtual scenes, a virtual object has different states, and priorities of the states can be set and changed as required. This may be not specifically limited herein. FIG. 13 is a schematic diagram of interruption priorities of the plurality of states.

The first virtual object can be bumped by another virtual object in the flight process. In this way, one attack of the controlled virtual object can trigger chain reactions of flight after hits and bumping into virtual objects, so that an actual effect generated by one attack may be greater than an effect generated by the attack, expanding an attack range, and further improving efficiency of human-computer interaction.

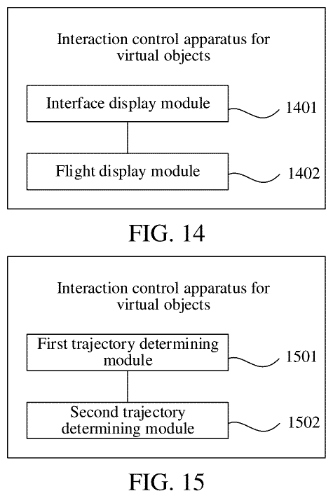

FIG. 14 is a block diagram of an interaction control apparatus for virtual objects. The apparatus is configured to perform operations of the foregoing interaction control method for virtual objects. Referring to FIG. 14, the apparatus includes:
an interface display module 1401, configured to display a virtual scene interface, a first virtual object being displayed in the virtual scene interface; and
a flight display module 1402, configured to display, in the virtual scene interface in response to a controlled virtual object hitting the first virtual object, that the first virtual object flies along a first flight trajectory after being hit, the controlled virtual object being a virtual object controlled by a terminal.

The flight display module 1402 may be further configured to display, in the virtual scene interface in response to a target part of the first virtual object being hit by a second virtual object in a flight process and the second virtual object satisfying a preset condition, that the first virtual object flies along a second flight trajectory after being hit.

In some examples, that the second virtual object satisfies the preset condition includes at least one of the following:
a capability value of the second virtual object satisfies a preset capability value; or
a virtual prop used by the second virtual object may be a preset prop.

In some examples, the apparatus further includes a hit point adjustment module, configured to:
determine a hit point adjustment ratio of the first virtual object based on the capability value of the second virtual object, and adjust hit points of the first virtual object based on the hit point adjustment ratio of the first virtual object, the hit point adjustment ratio of the first virtual object being in positive correlation with the capability value of the second virtual object.

In some examples, the flight display module 1402 may be configured to:
determine, from a plurality of flight forms based on a hit side of the first virtual object, a target flight form matching the hit side, the plurality of flight forms corresponding to a plurality of sides of the first virtual object, and the flight form being a body form in the flight process; and
display, in the virtual scene interface, that the first virtual object flies along the first flight trajectory in the target flight form.

In some examples, the apparatus further includes a bump display module, configured to:
display, in the virtual scene interface in response to the first virtual object bumping into a third virtual object in the flight process, that the third virtual object may be bumped.

In some examples, the bump display module may be configured to:
determine, based on a flight orientation of the first virtual object relative to the third virtual object, a target movement trajectory of the third virtual object after the third virtual object may be bumped; and
display, in the virtual scene interface based on the target movement trajectory, that the third virtual object moves along the target movement trajectory after being bumped.

In some examples, the bump display module may be configured to: perform extension by a preset distance along the flight orientation by using a location at which the third virtual object may be bumped as a start point, to obtain the target movement trajectory.

In some examples, the bump display module may be configured to: determine, from a plurality of bumped forms based on a bumped side of the third virtual object, a target bumped form matching the bumped side, the plurality of bumped forms corresponding to a plurality of sides of the third virtual object, and the bumped form being a body form of the third virtual object after the third virtual object may be bumped; and
display, in the virtual scene interface, that the third virtual object moves along the target movement trajectory in the target bumped form.

In some examples, the hit point adjustment module may be further configured to:
determine a hit point adjustment ratio of the first virtual object based on a capability value of the controlled virtual object, and adjust hit points of the first virtual object based on the hit point adjustment ratio of the first virtual object, the hit point adjustment ratio of the first virtual object being in positive correlation with the capability value of the controlled virtual object; and
determine a hit point adjustment ratio of the third virtual object based on the capability value of the controlled virtual object, and adjust hit points of the third virtual object based on the hit point adjustment ratio of the third virtual object, the hit point adjustment ratio of the third virtual object being in positive correlation with the capability value of the controlled virtual object.

In some examples, the bump display module may be further configured to:
display, in the virtual scene interface in response to the first virtual object being bumped by a fourth virtual object in the flight process, that the first virtual object may be bumped, the fourth virtual object being a flying virtual object.

In some examples, the apparatus further includes a trajectory determining module, configured to:
determine the first flight trajectory of the first virtual object based on a relative position relationship between the controlled virtual object and the first virtual object.

In some examples, the trajectory determining module may be configured to:
determine an extension line of a connecting line between the controlled virtual object and the first virtual object, use a location at which the first virtual object may be hit as a start point of the first flight trajectory, and use a direction of the extension line as a direction of the first flight trajectory at the start point.

In some examples, the apparatus further includes an end point adjustment module, configured to:
adjust an end point of the first flight trajectory when the end point of the first flight trajectory may be located in an inactive region in a virtual scene, so that an adjusted end point may be located in an active region in the virtual scene.

In some examples, the flight display module 1402 may be configured to:
display, in the virtual scene interface in response to the controlled virtual object hitting the first virtual object and a hit value of the first virtual object reaching a hit threshold, that the first virtual object flies along the first flight trajectory after being hit, the hit value being used to indicate a quantity of times that the first virtual object may be hit.

In some examples, the apparatus further includes a state adjustment module, configured to:
display, in the virtual scene interface in response to the first virtual object being hit while in a first state and a hit value reaching a hit threshold, that the first virtual object flies along the first flight trajectory after being hit, the first state including a bump state, a flight state, or a startled state; and
stop the flight process in response to the first virtual object reaching a second state in the flight process, the second state including the hit state, a stunned state, or a state that hit points may be reduced to a threshold.

This example provides the interaction control apparatus for virtual objects. The controlled virtual object may be controlled to hit the first virtual object, to trigger the first virtual object to fly after being hit, and after the target part of the first virtual object may be hit by a virtual object that satisfies the preset condition in the flight process, the first virtual object may be triggered to fly after being hit for the second time. According to the apparatus, the controlled virtual object can also interact with a flying virtual object, so that the controlled virtual object can interact with the first virtual object for a plurality of times in a short time. This improves efficiency of interacting with the first virtual object, and further improves human-computer efficiency.

FIG. 15 is a block diagram of an interaction control apparatus for virtual objects. The apparatus may be configured to perform operations of the foregoing interaction control method for virtual objects. Referring to FIG. 15, the apparatus includes:
a first trajectory determining module 1501, configured to determine, in response to a controlled virtual object in a virtual scene hitting a first virtual object, a first hit direction of the first virtual object based on a direction of an extension line of a connecting line between a root skeleton point of the controlled virtual object and a root skeleton point of the first virtual object, and determine a first flight trajectory based on the first hit direction as well as a first speed and a virtual weight of the first virtual object, so that the first virtual object flies along the first flight trajectory after being hit, the controlled virtual object being a virtual object controlled by a terminal; and
a second trajectory determining module 1502, configured to determine, in response to a target part of the first virtual object being hit in a flight process, a second hit direction of the first virtual object based on a direction of an extension line of a connecting line between a virtual prop hitting the first virtual object and the root skeleton point of the first virtual object, and determine a second flight trajectory based on the second hit direction as well as a second speed and the virtual weight of the first virtual object, so that the first virtual object flies along the second flight trajectory after being hit,
the first speed being a speed of the first virtual object in the first hit direction, and the second speed being a speed of the first virtual object in the second hit direction.

In some examples, the first trajectory determining module 1501 may be configured to:
determine, based on the first hit direction and the first speed, a first horizontal speed and a first vertical speed of the first virtual object, the first horizontal speed and the first vertical speed being speeds of the first virtual object in a horizontal direction and a vertical direction, respectively; and
determine locations of the first virtual object at a plurality of first time points based on a first hit location, the first horizontal speed, the first vertical speed, and the virtual weight of the first virtual object, to obtain the first flight trajectory, the plurality of first time points including a time point at which the first virtual object reaches an end point of the first flight trajectory and a time point before the end point may be reached.

In some examples, the second trajectory determining module 1502 may be configured to:
determine, based on the second hit direction and the second speed, a second horizontal speed and a second vertical speed of the first virtual object, the second horizontal speed and the second vertical speed being speeds of the first virtual object in the horizontal direction and the vertical direction, respectively; and
determine locations of the first virtual object at a plurality of second time points based on a second hit location, the second horizontal speed, the second vertical speed, and the virtual weight of the first virtual object, to obtain the second flight trajectory, the plurality of second time points including a time point at which the first virtual object reaches an end point of the second flight trajectory and a time point before the end point may be reached.

In this example, the first hit direction may be determined based on the direction of the extension line of the connecting line between the root skeleton points of the two virtual objects, and then the first flight trajectory may be determined with reference to the speed and the virtual weight in this direction. The first flight trajectory determined in this way conforms to a physical principle and has high accuracy, so that realistic flight effects can be presented when the first virtual object flies along the first flight trajectory. Similarly, the determined second flight trajectory conforms to the physical principle and has high accuracy, so that a realistic flight effect can be presented when the first virtual object flies along the second flight trajectory.

In the examples, the computer device may be a terminal or a server. When the computer device may be a terminal, the terminal may be used as an execution body to implement the technical solutions provided herein. When the computer device may be a server, the server may be used as an execution body to implement the technical solutions provided herein. Alternatively, the technical solutions provided in this application may be implemented through interaction between a terminal and a server.

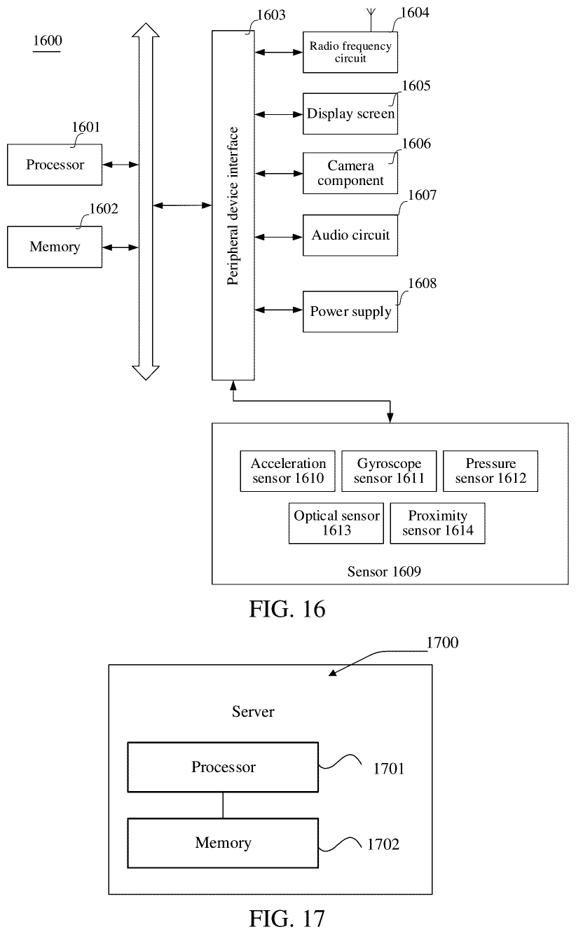

FIG. 16 is a block diagram of a structure of a terminal 1600. Generally, the terminal 1600 includes a processor 1601 and a memory 1602. The processor 1601 includes one or more processing cores, for example, a 4-core processor or an 8-core processor. The processor 1601 may be implemented in at least one hardware form of a digital signal processor (DSP), a field programmable gate array (FPGA), and a programmable logic array (PLA). Alternatively, the processor 1601 may include a main processor and a co-processor. The main processor may be a processor configured to process data in an awake state, and may be also referred to as a central processing unit (CPU). The co-processor may be a low-power-consumption processor configured to process data in a standby state. In some examples, the processor 1601 may be integrated with a graphics processing unit (GPU). The GPU may be configured to render and draw content that needs to be displayed on a display screen. In some examples, the processor 1601 may further include an AI processor. The AI processor may be configured to process computing operations related to machine learning.

The memory 1602 includes one or more computer-readable storage media. The computer-readable storage medium may be non-transitory. The memory 1602 may further include a high-speed random access memory and a nonvolatile memory, for example, one or more disk storage devices or flash storage devices. In some examples, the non-transitory computer-readable storage media in the memory 1602 may be configured to store at least one computer program. The at least one computer program may be used to be executed by the processor 1601, to implement the interaction control method for virtual objects.

In some examples, the terminal 1600 may further include a peripheral device interface 1603 and at least one peripheral device. The processor 1601, the memory 1602, and the peripheral device interface 1603 may be connected through a bus or a signal cable. Each peripheral device may be connected to the peripheral device interface 1603 through a bus, a signal cable, or a circuit board. Specifically, the peripheral device includes at least one of a radio frequency (RF) circuit 1604, a display screen 1605, a camera component 1606, an audio circuit 1607, and a power supply 1608.

The peripheral device interface 1603 may be configured to connect the at least one peripheral device related to input/output (I/O) to the processor 1601 and the memory 1602. In some examples, the processor 1601, the memory 1602, and the peripheral device interface 1603 may be integrated on a same chip or circuit board. In some other examples, any one or two of the processor 1601, the memory 1602, and the peripheral device interface 1603 may be implemented on an independent chip or circuit board. This may be not limited in this example.

The RF circuit 1604 may be configured to receive and transmit an RF signal, also referred to as an electromagnetic signal. The RF circuit 1604 communicates with a communication network and other communication devices through the electromagnetic signal. The RF circuit 1604 converts an electric signal into an electromagnetic signal for transmission, or converts a received electromagnetic signal into an electric signal. In some examples, the RF circuit 1604 includes an antenna system, an RF transceiver, one or more amplifiers, a tuner, an oscillator, a DSP, a codec chipset, a user identity module card, and the like. The RF circuit 1604 communicates with another terminal by using at least one wireless communication protocol. The wireless communication protocol includes but may be not limited to: the World Wide Web, a metropolitan area network, an internet, various generations of mobile communication networks (2nd generation (2G), 3rd generation (3G), 4th generation (4G), and 5th generation (5G)), a wireless local area network, and/or a wireless fidelity (Wi-Fi) network. In some examples, the RF 1604 may further include a circuit related to near field communication (NFC). This may be not limited in this application.

The display screen 1605 may be configured to display a user interface (UI). The UI includes a graph, text, an icon, a multimedia resource, and any combination thereof. When the display screen 1605 may be a touch display screen, the display screen 1605 further has a capability of acquiring a touch signal on or above a surface of the display screen 1605. The touch signal may be inputted to the processor 1601 as a control signal for processing. In this case, the display screen 1605 may be further configured to provide a virtual button and/or a virtual keyboard that are/is also referred to as a soft button and/or a soft keyboard. In some examples, there may be one display screen 1605 disposed on a front panel of the terminal 1600. In some other examples, there may be at least two display screens 1605 disposed on different surfaces of the terminal 1600 respectively or in a folded design. In some other examples, the display screen 1605 may be a flexible display screen disposed on a curved surface or a folded surface of the terminal 1600. Even, the display screen 1605 may be further set in a non-rectangular irregular pattern, that is, a special-shaped screen. The display screen 1605 may be manufactured by using a material such as a liquid crystal display (LCD) or an organic light-emitting diode (OLED).

The camera component 1606 may be configured to acquire images or multimedia resources. In some examples, the camera component 1606 includes a front-facing camera and a rear-facing camera. Generally, the front-facing camera may be disposed on the front panel of the terminal, and the rear-facing camera may be disposed on a back surface of the terminal. In some examples, there may be at least two rear-facing cameras, which may be respectively any one of a main camera, a depth-of-field camera, a wide-angle camera, and a telephoto camera, to achieve background blur through fusion of the main camera and the depth-of-field camera, panoramic photographing and VR photographing through fusion of the main camera and the wide-angle camera, or other fusion photographing functions. In some examples, the camera component 1606 further includes a flash. The flash may be a monochrome temperature flash, or may be a double color temperature flash. The double color temperature flash may be a combination of a warm light flash and a cold light flash, and may be configured for light compensation under different color temperatures.

The audio circuit 1607 includes a microphone and a speaker. The microphone may be configured to acquire sound waves of a user and an environment, convert the sound waves into an electrical signal, and input the electrical signal to the processor 1601 for processing, or input the electrical signal to the RF circuit 1604 for implementing voice communication. For the purpose of stereo acquisition or noise reduction, there may be a plurality of microphones disposed at different parts of the terminal 1600 respectively. The microphone may be be an array microphone or an omnidirectional collection microphone. The speaker may be configured to convert electric signals from the processor 1601 or the RF circuit 1604 into sound waves. The speaker may be a conventional film speaker, or may be a piezoelectric ceramic speaker. When the speaker may be the piezoelectric ceramic speaker, the speaker not only can convert an electric signal into acoustic waves audible to a human being, but also can convert an electric signal into acoustic waves inaudible to a human being, for ranging and other purposes. In some examples, the audio circuit 1607 further includes an earphone jack.

The power supply 1608 may be configured to supply power to components in the terminal 1600. The power supply 1608 may be an alternating current, a direct current, a disposable battery, or a rechargeable battery. When the power supply 1608 includes a rechargeable battery, the rechargeable battery may be a wired rechargeable battery or a wireless rechargeable battery. The wired rechargeable battery may be a battery charged through a wired circuit, and the wireless rechargeable battery may be a battery charged through a wireless coil. The rechargeable battery may be further configured to support a fast charge technology.

In some examples, the terminal 1600 further includes one or more sensors 1609. The one or more sensors 1609 include but may be not limited to: an acceleration sensor 1610, a gyroscope sensor 1611, a pressure sensor 1612, an optical sensor 1613, and a proximity sensor 1614.

The acceleration sensor 1610 detects a magnitude of acceleration on three coordinate axes of a coordinate system established with the terminal 1600. For example, the acceleration sensor 1610 may be configured to detect components of a gravity acceleration on the three coordinate axes. The processor 1601 can control, based on a gravity acceleration signal acquired by the acceleration sensor 1610, the display screen 1605 to display the UI in a landscape view or a portrait view. The acceleration sensor 1610 may be further configured to acquire motion data of a game or a user.

The gyroscope sensor 1611 detects a body direction and a rotation angle of the terminal 1600. The gyroscope sensor 1611 cooperates with the acceleration sensor 1610 to acquire a 3D action of the user on the terminal 1600. The processor 1601 implements the following functions based on the data acquired by the gyroscope sensor 1611: motion sensing (such as changing the UI based on a tilt operation of the user), image stabilization at shooting, game control, and inertial navigation. The pressure sensor 1612 may be disposed at a side frame of the terminal 1600 and/or a lower layer of the display screen 1605. When the pressure sensor 1612 may be disposed at the side frame of the terminal 1600, a holding signal of the user on the terminal 1600 may be detected. The processor 1601 performs left and right hand recognition or a quick operation based on the holding signal acquired by the pressure sensor 1612. When the pressure sensor 1612 may be disposed on the low layer of the display screen 1605, the processor 1601 controls an operable control on the UI, based on a pressure operation of the user on the display screen 1605. The operable control includes at least one of a button control, a scroll-bar control, an icon control, and a menu control.

The optical sensor 1613 may be configured to acquire an ambient light intensity. In an example, the processor 1601 controls display brightness of the display screen 1605 based on the ambient light intensity acquired by the optical sensor 1613. Specifically, when the ambient light intensity may be high, the display brightness of the display screen 1605 may be increased. When the ambient light intensity may be low, the display brightness of the display screen 1605 may be decreased. In another example, the processor 1601 may further dynamically adjust a camera parameter of the camera component 1606 based on the ambient light intensity acquired by the optical sensor 1613.

The proximity sensor 1614, also referred to as a distance sensor, may be generally disposed on the front panel of the terminal 1600. The proximity sensor 1614 may be configured to acquire a distance between the user and the front surface of the terminal 1600. In an example, when the proximity sensor 1614 detects that the distance between the user and the front surface of the computer device 1600 gradually decreases, the processor 1601 controls the display screen 1605 to switch from a screen-on state to a screen-off state. When the proximity sensor 1614 detects that the distance between the user and the front surface of the terminal 1600 gradually increases, the processor 1601 controls the display screen 1605 to switch from the screen-off state to the screen-on state. A person skilled in the art can understand that the structure shown in FIG. 16 does not constitute a limitation on the terminal 1600. The terminal can include more or fewer components than those shown in the figure, or some components may be combined, or different component arrangements may be used.

FIG. 17 is a schematic diagram of a structure of a server. The server 1700 may vary considerably depending on configuration or performance, and may include one or more CPUs 1701 and one or more memories 1702. The memory 1702 may be configured to store a computer program. The processor 1701 may be configured to execute the computer program, to implement the interaction control method for virtual objects provided in the method examples. Certainly, the server may further have components such as a wired or wireless network interface, a keyboard, and an I/O interface for input and output. The server further includes another component for implementing a device function. Details may be not described herein.

An example further provides a computer-readable storage medium, configured to store at least one segment of computer program, the at least one segment of computer program being loaded and executed by a processor to implement the interaction control method for virtual objects in any one of the foregoing examples.

An example further provides a computer program product, including a computer program, the computer program being stored in a computer-readable storage medium, a processor of a computer device reading the computer program from the computer-readable storage medium, and the processor executing the computer program, to cause the computer device to perform the interaction control method for virtual objects in any one of the foregoing examples. In some examples, the computer program product may be deployed to be executed on one computer device, executed on a plurality of computer devices at one location, or executed on a plurality of computer devices distributed at a plurality of locations and connected to each other through a communication network. The plurality of computer devices distributed at the plurality of locations and connected to each other through the communication network may form a blockchain system.

The foregoing descriptions may be merely exemplary examples, but may be not intended to limit this application. Any modification, equivalent replacement, or improvement made within the spirit and principle of this application shall fall within the protection scope of this application.

What is claimed is:

1. An interaction control method comprising:
outputting a virtual scene interface comprising a first virtual object;
receiving an instruction for a controlled virtual object to hit the first virtual object, wherein the controlled virtual object is being controlled by a terminal device;
generating, based on the instruction, a first flight trajectory of the first virtual object after the first virtual object is hit by the controlled virtual object;
moving, in the virtual scene interface, the first virtual object along the first flight trajectory;
receiving, while the first virtual object is moving along the first flight trajectory, a message that a target part of the first virtual object has been hit by a second virtual object;
generating, based on the message and the second virtual object satisfying a preset condition, a second flight trajectory of the first virtual object after the first virtual object is hit by the second virtual object; and
moving, in the virtual scene interface, the first virtual object along the second flight trajectory.

2. The method of claim 1, further comprising determining that the second virtual object satisfies the preset condition based on at least one of the following:
a capability value of the second virtual object satisfies a preset capability value; or
a virtual prop used by the second virtual object is a preset prop.

3. The method of claim 1, further comprising:
determining, based on a capability value of the second virtual object, a hit point adjustment ratio of the first virtual object, wherein the hit point adjustment ratio of the first virtual object is in positive correlation with the capability value of the second virtual object; and
adjusting, based on the hit point adjustment ratio of the first virtual object, hit points of the first virtual object.

4. The method of claim 1, wherein the generating the first flight trajectory of the first virtual object comprises determining, from a plurality of flight forms and based on a hit side of the first virtual object, a target flight form matching the hit side, wherein the plurality of flight forms corresponds to a plurality of sides of the first virtual object; and
wherein the moving the first virtual object along the first flight trajectory comprises displaying that the first virtual object is moving along the first flight trajectory in the target flight form.

5. The method of claim 1, further comprising:
receiving a second message that the first virtual object has bumping into a third virtual object; and
modifying the virtual scene interface to indicate that the third virtual object has been bumped.

6. The method of claim 5, wherein the modifying the virtual scene interface to indicate that the third virtual object has been bumped comprises:
determining, based on a flight orientation of the first virtual object relative to the third virtual object, a target movement trajectory of the third virtual object after the third virtual object is bumped; and
moving, in the virtual scene interface, the third virtual object along the target movement trajectory after being bumped.

7. The method of claim 6, wherein the determining the target movement trajectory of the third virtual object comprises:
performing extension by a preset distance along the flight orientation by using a location at which the third virtual object is bumped as a start point.

8. The method of claim 6, wherein the moving the third virtual object moves along the target movement trajectory comprises:
determining, from a plurality of bumped forms and based on a bumped side of the third virtual object, a target bumped form matching the bumped side, wherein the plurality of bumped forms corresponds to a plurality of sides of the third virtual object, and wherein the bumped form is a body form of the third virtual object after the third virtual object is bumped; and
displaying, in the virtual scene interface, that the third virtual object moves along the target movement trajectory in the target bumped form.

9. The method of claim 5, further comprising:
determining, based on a capability value of the controlled virtual object, a first hit point adjustment ratio of the first virtual object, wherein the first hit point adjustment ratio of the first virtual object is in positive correlation with the capability value of the controlled virtual object;
adjusting, based on the first hit point adjustment ratio of the first virtual object, first hit points of the first virtual object;
determining, based on the capability value of the controlled virtual object, a second hit point adjustment ratio of the third virtual object, wherein the second hit point adjustment ratio of the third virtual object is in positive correlation with the capability value of the controlled virtual object; and
adjusting, based on the hit point adjustment ratio of the third virtual object, second hit points of the third virtual object.

10. The method of claim 1, further comprising:
receiving a second message that the first virtual object has been bumped by a flying virtual object; and
modifying the virtual scene interface to indicate that the first virtual object has been bumped by the flying virtual object.

11. The method of claim 1, wherein the generating the first flight trajectory comprises:
determining, based on a relative position relationship between the controlled virtual object and the first virtual object, the first flight trajectory of the first virtual object.

12. The method of claim 11, wherein the determining the first flight trajectory of the first virtual object comprises:
determining an extension line of a connecting line between the controlled virtual object and the first virtual object by using:
a location at which the first virtual object is hit as a start point of the first flight trajectory; and
a direction of the extension line as a direction of the first flight trajectory at the start point.

13. The method of claim 1, further comprising:
adjusting an end point of the first flight trajectory when the end point of the first flight trajectory is located in an inactive region in a virtual scene, wherein the adjusted end point is located in an active region in the virtual scene.

14. The method of claim 1, wherein the moving the first virtual object flies along the first flight trajectory comprises:
displaying, in the virtual scene interface, and based on a hit value of the first virtual object reaching a hit threshold, that the first virtual object is moving along the first flight trajectory, wherein the hit value indicates a quantity of times that the first virtual object is hit.

15. The method of claim 1, further comprising:
displaying, in the virtual scene interface and in response to the first virtual object being hit while in a first state and a hit value reaching a hit threshold, that the first virtual object flies along the first flight trajectory, wherein the first state comprises a bump state, a flight state, or a startled state; and
stopping a movement of the first virtual object in response to the first virtual object reaching a second state, wherein the second state comprises the hit state, a stunned state, or a state where hit points are reduced to a threshold.

16. One or more non-transitory computer readable media comprising computer readable instructions which, when executed, configure a data processing system to perform:
outputting a virtual scene interface comprising a first virtual object;
receiving an instruction for a controlled virtual object to hit the first virtual object, wherein the controlled virtual object is being controlled by a terminal device;
generating, based on the instruction, a first flight trajectory of the first virtual object after the first virtual object is hit by the controlled virtual object;
moving, in the virtual scene interface, the first virtual object along the first flight trajectory;
receiving, while the first virtual object is moving along the first flight trajectory, a message that a target part of the first virtual object has been hit by a second virtual object;
generating, based on the message and the second virtual object satisfying a preset condition, a second flight trajectory of the first virtual object after the first virtual object is hit by the second virtual object; and
moving, in the virtual scene interface, the first virtual object along the second flight trajectory.

17. The one or more non-transitory computer readable media of claim 16, wherein the computer readable instructions, when executed, further configure the data processing system to perform determining that the second virtual object satisfies the preset condition based on at least one of the following:
a capability value of the second virtual object satisfies a preset capability value; or
a virtual prop used by the second virtual object is a preset prop.

18. The one or more non-transitory computer readable media of claim 16, wherein the computer readable instructions, when executed, further configure the data processing system to perform:
determining, based on a capability value of the second virtual object, a hit point adjustment ratio of the first virtual object, wherein the hit point adjustment ratio of the first virtual object is in positive correlation with the capability value of the second virtual object; and
adjusting, based on the hit point adjustment ratio of the first virtual object, hit points of the first virtual object.

19. The one or more non-transitory computer readable media of claim 16, wherein the computer readable instructions, when executed, further configure the data processing system to perform the generating the first flight trajectory of the first virtual object by determining, from a plurality of flight forms and based on a hit side of the first virtual object, a target flight form matching the hit side, wherein the plurality of flight forms corresponds to a plurality of sides of the first virtual object; and
wherein the computer readable instructions, when executed, further configure the data processing system to perform the moving the first virtual object along the first flight trajectory by displaying that the first virtual object is moving along the first flight trajectory in the target flight form.

20. An apparatus, comprising:
a processor; and
memory storing computer readable instructions which, when executed, configure the apparatus to perform:
outputting a virtual scene interface comprising a first virtual object;
receiving an instruction for a controlled virtual object to hit the first virtual object, wherein the controlled virtual object is being controlled by a terminal device;
generating, based on the instruction, a first flight trajectory of the first virtual object after the first virtual object is hit by the controlled virtual object;
moving, in the virtual scene interface, the first virtual object along the first flight trajectory;
receiving, while the first virtual object is moving along the first flight trajectory, a message that a target part of the first virtual object has been hit by a second virtual object;
generating, based on the message and the second virtual object satisfying a preset condition, a second flight trajectory of the first virtual object after the first virtual object is hit by the second virtual object; and
moving, in the virtual scene interface, the first virtual object along the second flight trajectory.
